(19) United States
(12) Patent Application Publication
(10) Pub. No.: US 2022/0243688 A1
(43) Pub. Date: Aug. 4, 2022

(54) VALVE DEVICE

(71) Applicant: ElringKlinger AG, Dettingen an der Erms (DE)

(72) Inventors: Philipp ROTH, Dettingen an der Erms (DE); Wojtek KOLASINSKI, Dettingen an der Erms (DE)

(73) Assignee: ElringKlinger AG, Dettingen an der Erms (DE)

(21) Appl. No.: 17/617,248

(22) PCT Filed: May 6, 2020
(86) PCT No.: PCT/EP2020/062559

§ 371 Date: Dec. 7, 2021

(30) Foreign Application Priority Data
Jun. 7, 2019 (DE) 10 2019 115 633.5

(51) Int. Cl. F02M 26/67; F02M 26/68

(52) U.S. Cl. CPC F02M 26/67; F02M 26/61; F02M 26/68

(57) ABSTRACT

A valve device for exhaust gas recirculation in the exhaust gas system of a motor vehicle that is driven by an internal combustion engine. In order to create a valve device that can be used as an EGR check valve in which a pressure loss relative to known designs is reduced even with small valve geometries, it is proposed for the valve device to comprise a valve body that is embodied as a separate part that is mushroom-shaped or umbrella-shaped and is axially guided in a supporting plate in a region through which the gas flows axial, rests with its umbrella against the supporting plate in a way that seals the region through which the gas flows in a closed position, and has an end stop for an open position.

The present invention relates to a valve device for an exhaust gas recirculation in an exhaust gas system of a motor vehicle that is driven by an internal combustion engine.

In current internal combustion engines, part of the exhaust gases that are produced are conveyed back to a combustion process in the internal combustion engine in order to reduce pollutant emissions. Because of the pressure pulsations produced by the combustion process, a pressure on an exhaust gas recirculation side can temporarily be lower than the pressure on a boost air side. This pressure difference would result in an undesirable reverse flow of exhaust gas into the exhaust gas recirculation zone. In order to prevent this, valve devices are used as so-called EGR check valves, which can open only in the direction toward the boost air side. A valve device is known from the prior art, among other things from DE 199 53 198 A1, which can be used as a check valve for the above-mentioned purpose. In addition, a valve device according to DE 10 2005 059 120 B3 includes an essentially rectangular flange geometry. It is thus known for such check valves to be produced in various designs, e.g., composed of sheet metal layers that are modularly stacked and screwed or welded to one another or composed of a cast body with sheet metal layers affixed to it. This design composed of a cast body with sheet metal layers, however, requires not only a large number of parts, but also a very large amount of installation space and a high overall weight.

One problem with known EGR check valves lies in the fact that as valve geometry decreases, the pressure loss generated is no longer functionally reliable. In addition, the modular valve design is limited with regard to manufacturability and durability.

The object of the present invention, therefore, is to create a valve device that can be used as an EGR check valve and in which even with small valve geometries, a pressure loss is reduced relative to known valve designs.

This object is attained according to the invention by the features of claim 1 in that the valve device comprises a valve body, which is embodied as a separate part, is mushroom-shaped or umbrella-shaped, and is axially guided in a supporting plate in a region through which the gas flows. In a closed position, the valve body rests with its umbrella against the supporting plate in a way that seals the region through which the gas flows and has an end stop for an open position in which the region through which the gas flows is maximally unblocked. A valve device according to the invention therefore comprises a movable valve body that is essentially the shape of a mushroom fruiting body or of a stick umbrella when it is open. The fruiting body of a classic mushroom consists of a stem and cap and with a comparable outer structure and a stick umbrella consists of a canopy and a stick. In both visual comparisons, the cap and canopy are clearly used for the sealing function in a closed end position of the valve against or on the supporting plate in order to seal the region through which the gas flows. When the valve body, which is able to move freely in the axial direction along the stem or stick, lifts off from the supporting plate, this produces an opening of the valve by unblocking the region through which the gas flows in the supporting plate.

In the proposed solution, the valve body with its particular outer shape is guided in its movement between two end points. This yields a compact valve design, which makes it possible for there to be significantly larger cross-sections and thus reduces the pressure loss that occurs. Since this design does not have a restoring element, e.g., in the form of a spring or even a leaf spring that is clamped in place at the end, this improves a response behavior when there are changes in the pressure conditions on this side and on the other side of the valve body since it is not necessary, for example, to overcome any spring forces. The boost pressure or exhaust gas pressure produced therefore keeps the valve either closed or open. It is thus possible to open or close the valve when there are significantly lower pressure differences. A valve device according to the invention is embodied very compactly and can therefore be used in very cramped installation spaces and advantageously also in ones that are not rectangular.

Advantageous modifications are the subject of the respective dependent claims. A stopper layer accordingly constitutes the end stop for the mushroom-shaped or umbrella-shaped valve body in the open position. The supporting plate and stopper layer form a stack of easy-to-manufacture sheet metal segments between which the valve body can move.

Advantageously, the mushroom-shaped or umbrella-shaped body is guided by means of a rod in an opening in the supporting plate and/or the stopper layer. This guidance in the supporting plate and/or the stopper layer is carried out by means of a movable support of the stem of the mushroom or of the stick of the umbrella acting as a rod in the supporting plate and/or the stopper layer. Such a rod has a straight length in a movement direction of the valve body, which is sufficient for the axial guidance in a correspondingly dimensioned hole.

In a preferred embodiment of the invention, the supporting plate and the stopper layer have at least one opening for exhaust gases flowing through and a plain bearing serving as a guide for the rod of the valve body. It is thus possible to produce simply embodied designs of the supporting plate and stopper layer, which can in particular be manufactured in the form of simple stamped or laser-cut parts. In one embodiment of the invention, a stopper layer that is provided with at least one flow openings and is three-dimensionally deformed constitutes the end stop for the mushroom-shaped or umbrella-shaped valve body. The stopper layer thus defines a maximum valve stroke.

In an advantageous modification of the invention, the at least one opening in the supporting plate and in the stopper layer are embodied as congruent and positioned in alignment in the flow direction of the exhaust gases. This minimizes turbulence and deflections in the region of the openings, which otherwise have a negative impact in the form of an increased pressure loss.

In a modification of the invention, the supporting plate and the stopper layer have openings that correspond to a screw hole for the screw-mounting of the flanges at the end. The above-described arrangement can thus be directly combined with standard flanges and can easily be screw-mounted in a durably sealed fashion.

Preferably, the stopper layer and supporting plate are at least partially connected to each other in a non-positive, positive, and/or integrally joined fashion. This results in a valve device according to the invention in the form of an easy-to-maneuver and easy-to-install unit with the movable valve body between the supporting plate that is firmly connected to the stopper layer. This connection between the stopper layer and supporting plate is preferably situated outside of a sealing layer, as described in greater detail below based on an exemplary embodiment.

According to a particularly advantageous embodiment of the invention, the stopper layer and the supporting plate are embodied as respective seals. These seals durably and reliably provide a required leak-tightness between the flanges of a pipe connection or of a fastening of a pipe to a housing part even in temperature ranges above 200° C.

In one embodiment of the invention, a guide of the valve body is embodied as a plain bearing in the form of a sleeve; in other words, two sleeves are provided for the guides in one embodiment of the invention. In this connection, the person skilled in the art knows that by taking into account known material pairings, a sleeve can be durably fastened in an opening in a simple and reliable way. Instead of using sleeves in the form of separate components, it is also possible to select a single-material solution in that for example a material of the relevant sheet metal part that is already present can be beaded and/or deep drawn to form a guide. Both measures can provide an axial guidance for the rod of the valve body. Friction-reducing coatings that are known to the person skilled in the art can easily be provided in this region so that it is possible to eliminate at least one additional part.

In a modification of the invention, the valve device has at least one additional seal, which provides an improvement in the sealing functionality between the flanges. To accomplish this, the additional seal is preferably embodied as a metal bead seal that produces a very good seal into high temperature ranges and even when there are large temperature fluctuations.

Throughout all of the above-described modifications of the invention, the mushroom-shaped or umbrella-shaped valve body itself is embodied in one piece in the form of an injection-molded, formed, milled, or turned part. The valve body consists of a thermally resistant material such as a metal or plastic.

According to an alternative embodiment of the invention, the mushroom-shaped or umbrella-shaped valve body is provided with a rod in the form of a hollow, cylindrical stem, which has openings adjoining the umbrella that are formed and distributed, preferably uniformly, around a circumference of the rod in such a way that these openings are closed by the sliding sleeve in a second endpoint position and the umbrella is positioned resting against the supporting plate in a sealed fashion. In a first endpoint position or open end position, these openings are unblocked.

As an alternative to embodying the second endpoint position of the valve device by means of a stopper layer, the rod of the valve body has at least one detent projection or an outward-pointing collar, e.g., produced by means of crimping or a similar material deformation, at one free end. The detent projection or the collar then cooperates with an axial guide to define a maximum stroke of the valve body in the second endpoint position.

Other features and advantages of embodiments according to the invention will be explained in greater detail below with reference to exemplary embodiments based on the drawings. In schematic depictions:

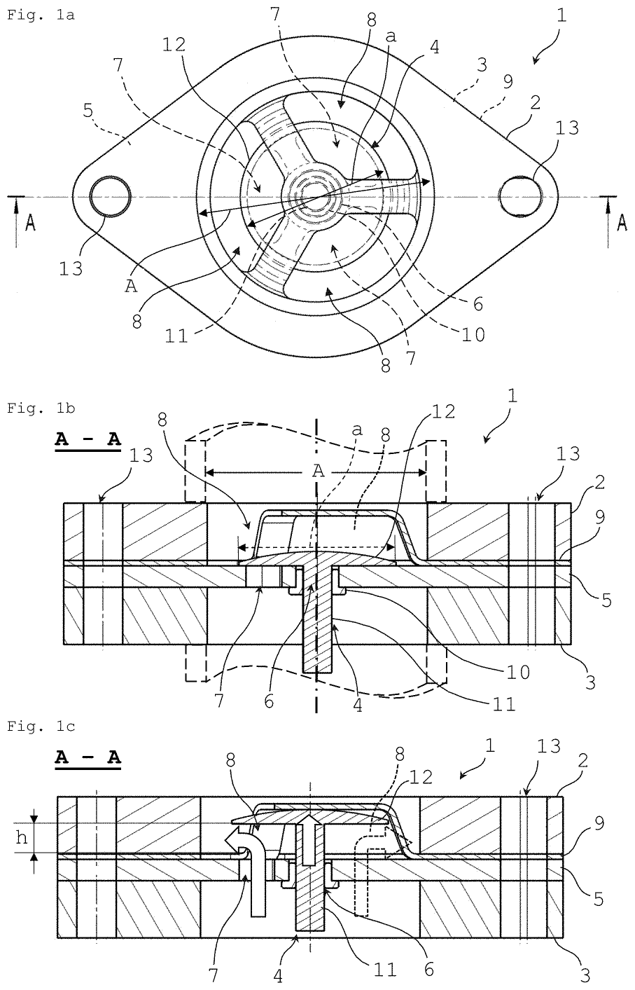

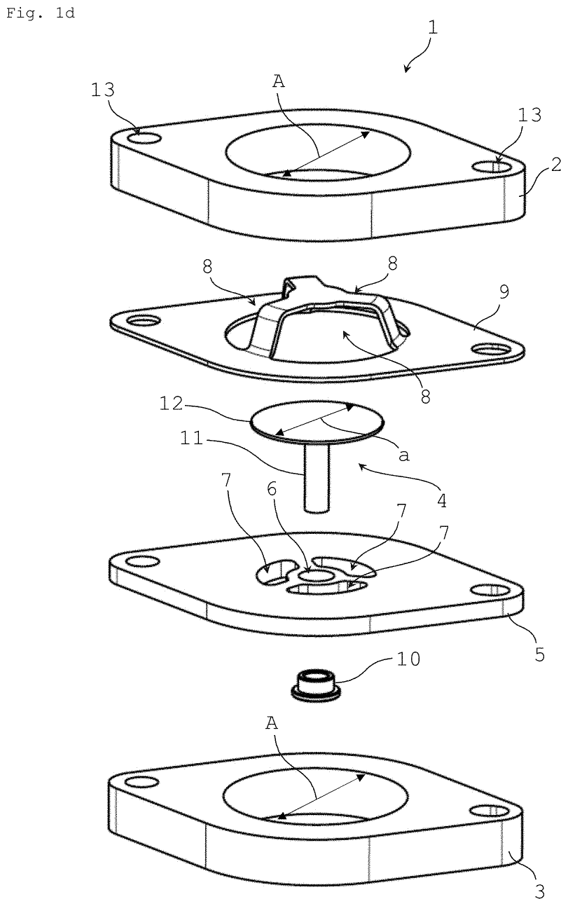

FIGS. 1a to 1d:

show a top view of a first exemplary embodiment of a valve device with cutaway views in a plane A-A with the valve device open and closed and in an exploded view;

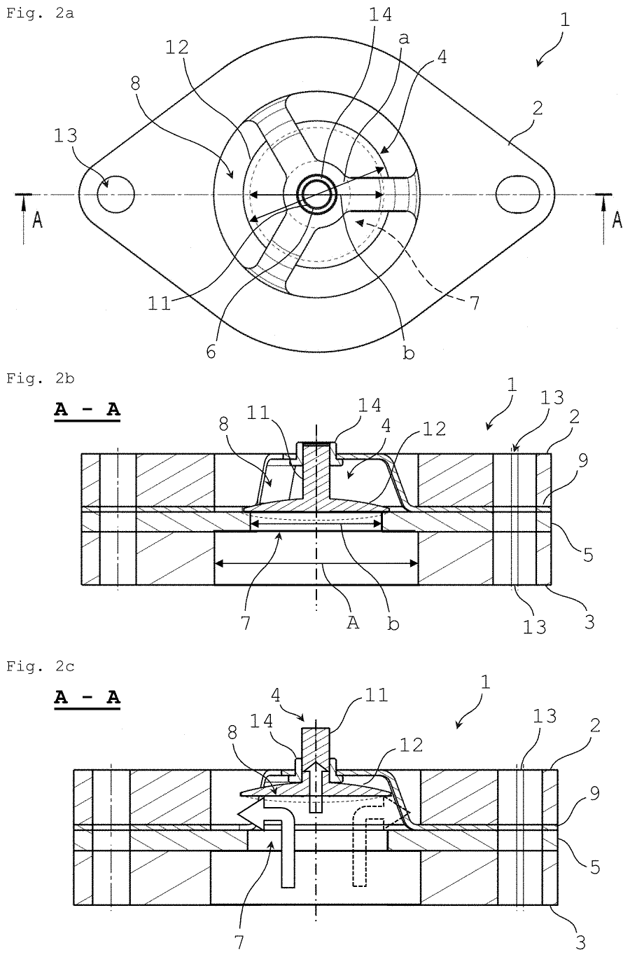

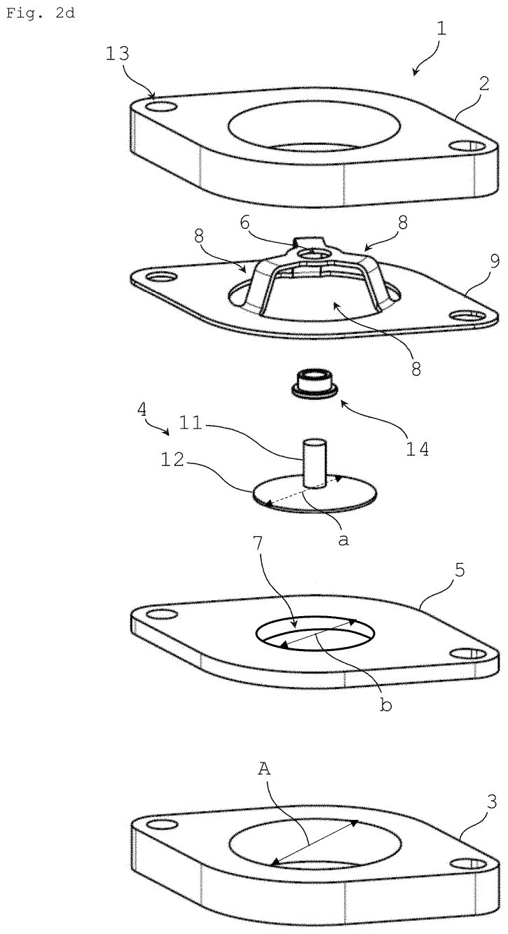

FIGS. 2a to 2d:

show a depiction of second exemplary embodiment of a valve device analogous to FIGS. 1a to 1d;

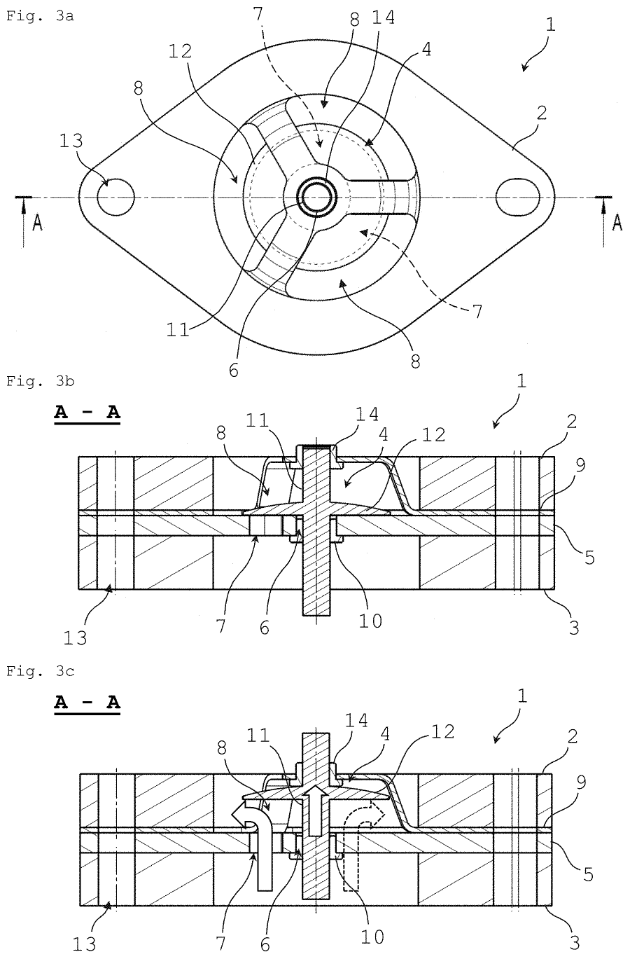

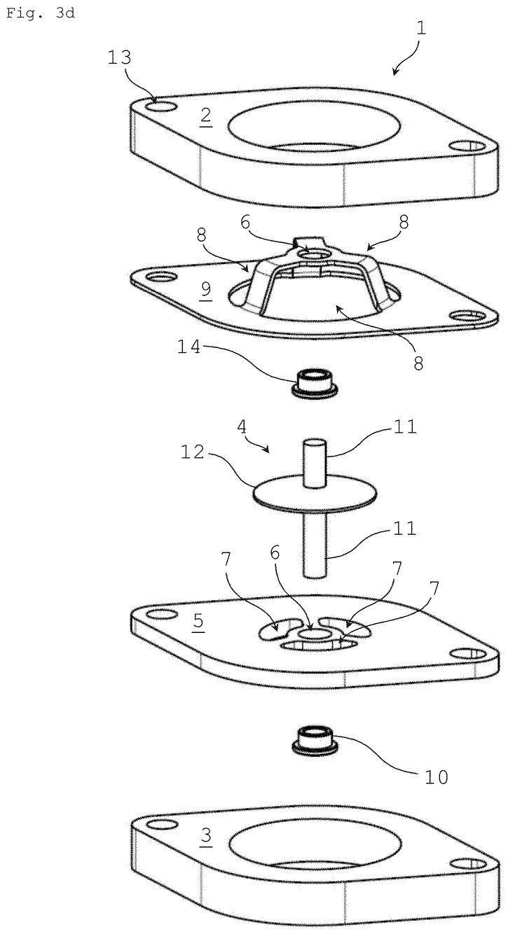

FIGS. 3a to 3d:

show a depiction of a third exemplary embodiment of a valve device analogous to FIGS. 1a to 1d;

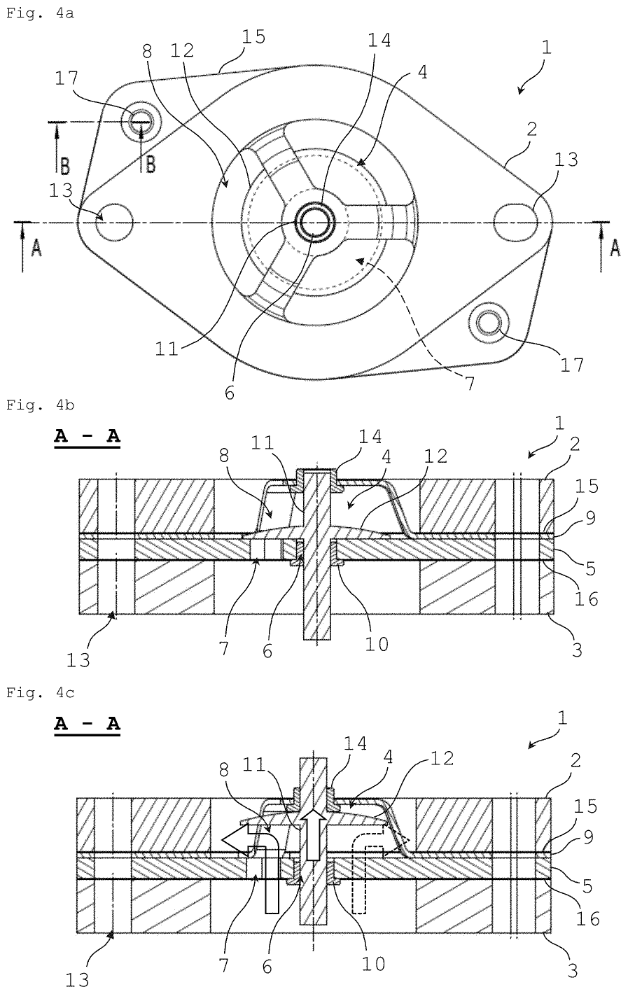

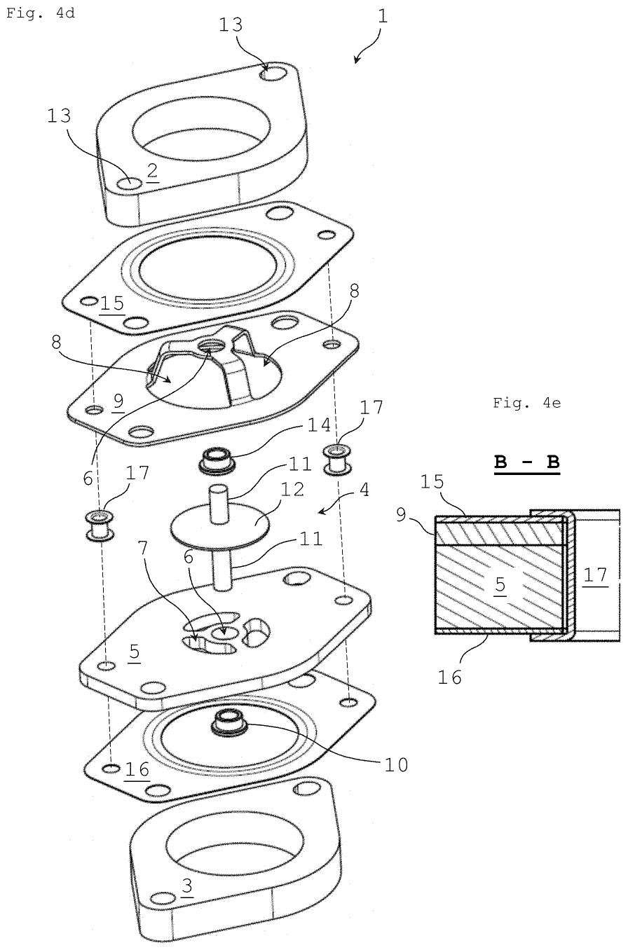

FIGS. 4a to 4e:

show a depiction of a fourth exemplary embodiment of a valve device analogous to FIGS. 3a to 3d and a cutaway view in order to depict a sealing functionality of this design composed of the stopper layer, supporting plate, and additional bead seals for sealing between the flanges;

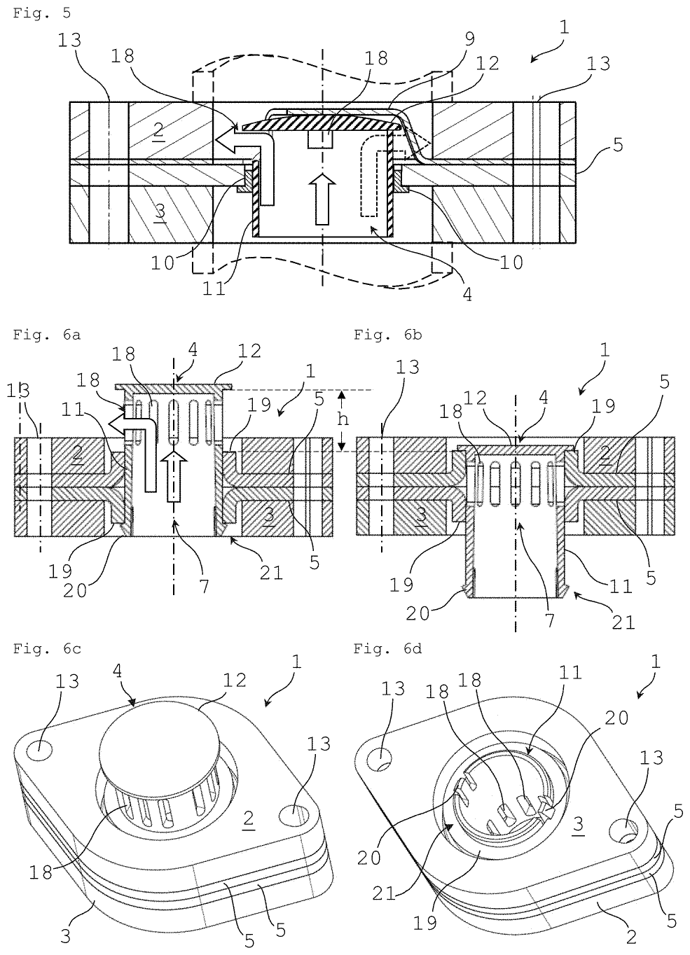

FIG. 5: shows a depiction of a fifth exemplary embodiment of a valve device analogous to the depictions in FIGS. 1c and 2c; and

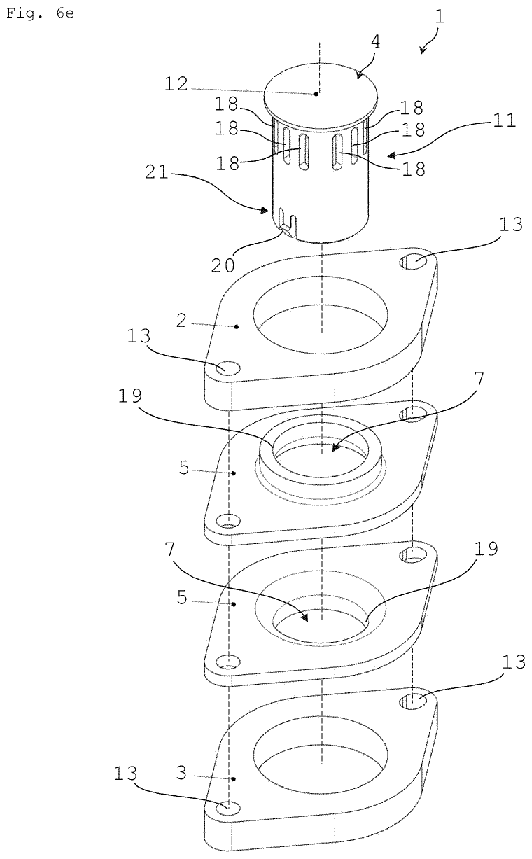

FIGS. 6a to 6e:

show a modification of the exemplary embodiment from FIG. 5 in cutaway views, perspective views from above and below, and in an exploded view.

Throughout the different drawings and exemplary embodiments, the same reference numerals are always used for the same elements.

The diagram in FIG. 1a shows a top view of a first exemplary embodiment of a valve device 1, which is clamped between two flanges 2, 3 as a detail of an exhaust gas recirculation, not shown further, in the exhaust gas system of a motor vehicle driven by an internal combustion engine. An internal structure is shown in the cutaway view in a plane A-A of FIG. 1a, with the valve device 1 shown in the closed state as FIGS. 1b and 1n the open state as FIG. 1c. The valve device 1 has a valve body 4, which is embodied as a separate, rotationally symmetrical body that is mushroom-shaped or umbrella-shaped. This valve body 4 is guided in an axially movable fashion between two end points in an opening 6 in a region of a supporting plate 5. Around the opening 6, three radially distributed openings 7 are provided through which an exhaust gas flows through the valve device 1 in an open position of the valve device 1 and in order to do so, brings the valve body 4 into an open position in the manner depicted. In this open position constituting a first endpoint, the valve body 4 rests against an end stop, which is formed by a cap-shaped stopper layer 9 that is provided with flow openings 8. In a closed position constituting a second endpoint, the valve body 4 rests against the three openings 7 and supporting plate 5 in a sealed fashion.

The opening 6 in the supporting plate 5 is provided with a sliding sleeve 10, which can consist of Teflon, copper, and/or stainless steel. A rod 11 of the valve body 4 is guided in an axially movable fashion in this sliding sleeve 10 so that the openings 7 serving as flow openings of the supporting plate 5 are closed in a sealed fashion by the pressing of a head 12 of the valve body 4 against the supporting plate 5. The valve device 1 in this case therefore only comprises a mushroom-shaped or umbrella-shaped valve body 4 consisting of a head 12 and rod 11 and in this case, is guided between two end positions by means of its rod 11 in the supporting plate 5. The supporting plate 5 constitutes an end stop for a closed end position and the cap-shaped stopper layer 9 constitutes a second end stop that establishes a maximum opening or a valve stroke h of the valve device 1, see FIG. 1c.

In comparison to known EGR check valves, a flow through the valve device 1 is improved among other things in that in this case, a free pipe cross-section A can be almost entirely used by the valve body 4 with a diameter a of the head 12, as indicated in FIG. 1b. On the other side of the surface of the opening 6, a large percentage of the free pipe cross-sectional area A on the supporting plate 5 is available for the formation of flow openings in the form of the openings 7. As a result, a valve device 1 of this kind advantageously has a comparatively low flow resistance.

The valve device 1 is also embodied as a seal, which is positioned between the flanges 2, 3 in a durably sealing fashion. For this purpose, the supporting plate 5 and the stopper layer 9 have an outer shape, which corresponds to the standard shape of the flanges 2, 3. In addition, the supporting plate 5 and stopper layer 9 also have screw holes 13, which are positioned in axial alignment with the screw-mounts of the flanges 2, 3.

FIGS. 2a to 2d show depictions of a second exemplary embodiment of a valve device analogous to FIGS. 1a to 1d in which a guide 14 of the mushroom-shaped or umbrella-shaped valve body 4 is now provided in the stopper layer 9. Due to the shape of the head 12, the valve body 4 represents a reversed umbrella, so to speak. In a way that is not shown, the valve body 4 can also be used rotated by 180° from the position shown in FIGS. 1a to 1d. In addition, the head 12 can also be provided with an additional guidance inside the deep-drawn structure of the stopper layer 9.

In a way that is not shown in greater detail, the opening 7 in the supporting plate 5 can be provided with a bevel, which, during the closing, achieves an additional self-centering in the region of the head 12 of the valve body 4 against the now single opening 7. This results in a diameter b of a single circular opening in the supporting plate 5 serving as a flow opening, which can be selected to be negligibly smaller than the diameter a of the head 12 of the valve body 4 without this negatively affecting the leak-tightness of the valve device 1, see FIG. 2b. Consequently, this embodiment features a particularly low flow resistance due to the advantageous flow configuration.

FIGS. 3a to 3d show depictions of a third exemplary embodiment of a valve device analogous to FIGS. 1a to 1d in which a second guide 14 of the mushroom-shaped or umbrella-shaped valve body 4 is now provided in the stopper layer 9 in order to be able to ensure an even more reliable guidance of the valve body 4. To accomplish this, the rod 11 of the valve body 4 has been correspondingly extended above the head 12 so that guides in the form of sliding sleeves 10, 14 ensure an axial guidance of the valve body 4 at all times. In this exemplary embodiment, guides for the rod 11 of the umbrella valve 4 are thus provided in the stopper layer 9 and the supporting plate 5, respectively. The rod 11 of the valve body 4 is thus guided in sliding fashion in the supporting plate 5 on the one hand and in the stopper layer 9 on the other hand, with low friction thanks to the sliding sleeves 10, 14. This safeguards the movable valve body 4 against tilting even more reliably than is achieved by only a single axial guide alone.

FIGS. 4a to 4e show a fourth exemplary embodiment of a valve device 1 analogous to FIGS. 2a to 2d in which the valve device 1 has at least one additional seal. In this exemplary embodiment, two additional seals 15, 16 are provided adjoining the stopper layer 9 and the supporting plate 5. The seals 15, 16 are provided in order to improve the sealing function of the valve device 1 relative to the flanges 2, 3 and in this exemplary embodiment, are embodied as metal bead seals.

In this case, the stopper layer 9 and the supporting plate 5 are also connected to each other by means of rivets 17 via the two additional seals 15, 16. These rivets 17 lie outside of an actual sealing region and thus also outside of the flanges 2, 3. The cutaway view in FIG. 4e shows a depiction of a sealing functionality that is improved by means of this structure composed of the stopper layer 9, supporting plate 5, and additional bead seals 15, 16 between the flanges 2, 3, with a cut-away view of a rivet 17.

FIG. 5 shows a depiction of a fifth exemplary embodiment of a valve device 1. In this instance, the valve body 4 is provided with a rod 11 in the form of a hollow, cylindrical stem. The rod 11 has openings 18 adjacent to the head or umbrella 12, which in this example, are positioned so that they are evenly distributed around the circumference. These opening are fully unblocked only if the valve body 4 is resting against the stopper layer 9, i.e. in the open endpoint position. By contrast with the exemplary embodiments described above, in this case, therefore, flow opening 8 distributed radially around the opening 6 are no longer provided and instead, only the openings 18. In a second endpoint position, the umbrella 12 rests against the supporting plate 5 in a sealed fashion.

The depictions in FIGS. 6a to 6e constitute a modification of the exemplary embodiment from FIG. 5 such that in this example, the supporting plate 5 is embodied as doubled and instead of using a sliding sleeve, a material of the sheet metal parts 5, 5, which is already present, has been deep-drawn in mirror-image fashion to form an axial guide 19. From the cutaway view in FIG. 6a, it is also clear that now, a stopper layer 9 is no longer provided in order to define a second endpoint of the valve body 4. Instead, detent projections 20 are provided at a free end 21 of the hollow stem 11, which together with the axial guide 19 define a maximum stroke h of the valve body 4. FIG. 6c shows the compact design of this exemplary embodiment in a perspective top view in the maximally open position. FIG. 6d shows an associated view from below in order to better depict the detent projections 20 that are used here cooperating with the axial guide 19. It is clear from this depiction that a use of at least one detent projection 20 at the free end 21 is not limited to an exemplary embodiment with a valve body 4 having a hollow stem 11. By using an alternative production method, instead of a detent projection 20, a circumferential collar around the outside of the free end 21 can also be provided as the second end stop, which is not graphically depicted in greater detail here.

FIG. 6e additionally shows an example for a simple assembly of this exemplary embodiment in the form of an exploded view. Simply through insertion of the valve body 4, all of the components can already be fastened in a way that permits their position to be adjusted relative to one another; the above-cited means for fastening components to one another can also be provided in order to facilitate a rapid and reliable installation, which is not graphically depicted in greater detail here.

The mushroom-shaped or umbrella-shaped valve body 4 is embodied with a rod 11 and head 12 in one piece in the form of an injection-molded, formed, milled, or turned part, which consists of a material that is thermally resistant up to approx. 300° C. In all of the exemplary embodiments described above, the mushroom-shaped or umbrella-shaped valve body 4 closes automatically as a function of the pressure that is present and does not require any additional restoring force of the kind that in known devices, must be produced by means of an elastically clamped spring, for example. Due to its low mass, the above-described valve device 1 also features a rapid response behavior.

Furthermore, the valve device 1 shown can be used for non-rectangular geometries that are frequently present, making very good use of the available space, directly and without adaptation or additional seals in the region of a flange connection. For this reason alone—without the invention being limited to this geometry—a pipe with a circular free pipe cross-section of the kind found in an exhaust gas cooler in exhaust gas systems of modern motor vehicles has been selected for the above-described graphic depiction of the exemplary embodiments of the invention.

### REFERENCE NUMERAL LIST

1 valve device
2 flange
3 flange
4 valve body
5 supporting plate as the sealing partner of the valve body 4
6 opening for guiding the valve body 4 in the supporting plate 5/stopper layer 9
7 flow opening in the supporting plate 5, possibly distributed radially around the opening 6
8 flow opening embodied as an opening in the stopper layer 9
9 stopper layer
10 sliding sleeve in the supporting plate 5
11 rod of the valve body 4
12 head of the valve body 4/umbrella
13 screw hole for a flange connection
14 sliding sleeve positioned as a guide in the stopper layer 9
15 metal bead seal
16 metal bead seal
17 rivet
18 opening in the hollow rod 11 close to the umbrella 12
19 axial guide
20 detent projection
21 free end of the hollow stem/rod 11 of the valve body 4
a head-diameter of the valve body 4
A free pipe cross-sectional area
b diameter of a single circular opening in the supporting plate 5 as a flow opening
h valve stroke

1. A valve device for an exhaust gas recirculation in an exhaust gas system of a motor vehicle that is driven by an internal combustion engine, which is made to be clamped between two flanges of the exhaust gas recirculation,
the valve device comprises a valve body, which is embodied as a separate part that is mushroom-shaped or umbrella-shaped,
that is axially guided in a supporting plate in a region through which the gas flows, rests with its umbrella against the supporting plate in a way that seals the region through which the gas flows in a closed position, and has an end stop for an open position.

2. The valve device according to claim 1, wherein a stopper layer constitutes the end stop for the mushroom-shaped or umbrella-shaped valve body in the open position.

3. The valve device according to claim 2, wherein the mushroom-shaped or umbrella-shaped valve body is guided by means of a rod in an opening of the supporting plate and/or the stopper layer.

4. The valve device according to claim 3, wherein the supporting plate and the stopper layer have at least one opening for flowing exhaust gases and a plain bearing serving as a guide of the rod.

5. The valve device according to claim 4, wherein the at least one opening in the supporting plate and in the stopper layer are embodied as congruent and are positioned in alignment in the flow direction of the exhaust gases.

6. The valve device according to claim 2, wherein the supporting plate and the stopper layer have openings corresponding to a screw hole of the flanges at the end.

7. The valve device according to claim 2, wherein the stopper layer and the supporting plate are at least partially connected to each other in a non-positive, positive, and/or integrally joined fashion.

8. The valve device according to claim 2, wherein the stopper layer and supporting plate are embodied as seals for the flanges.

9. The valve device according to claim 1, wherein a guide of the mushroom-shaped or umbrella-shaped valve body is embodied as a plain bearing in the form of a sliding sleeve.

10. The valve device according to claim 2, wherein a material of the relevant sheet metal part that is already present is folded over and/or deep-drawn in order to form an axial guide.

11. The valve device according to claim 1, wherein the valve device has at least one additional seal for the sealing function relative to the flanges.

12. The valve device according to claim 11, wherein the additional seal is embodied as a metal bead seal that is connected to the stopper layer and the supporting plate.

13. The valve device according to claim 1, wherein the mushroom-shaped or umbrella-shaped valve body is embodied as an injection-molded, formed, milled, or turned part, which consists of a thermally resistant material.

14. The valve device according to claim 1, wherein the mushroom-shaped or umbrella-shaped valve body is provided with a rod in the form of a hollow, cylindrical stem, which has openings adjoining the umbrella, which are positioned distributed around a circumference of the rod.

15. The valve device according to claim 1, wherein the rod has at least one detent projection or a collar at a free end, which together with an axial guide defines a maximum stroke of the valve body.
